(19) United States
(12) Patent Application Publication
(10) Pub. No.: US 2016/0212265 A1
(43) Pub. Date: Jul. 21, 2016

(54) ENHANCED CUSTOMER JOURNEY USING MULTICHANNEL CONTACT CENTER

(71) Applicant: Avaya Inc., Santa Clara, CA (US)

(72) Inventors: Laurent Philonenko, San Francisco, CA (US); Venkatesh Krishnaswamy, San Ramon, CA (US); Parameshwaran Krishnan, Basking Ridge, NJ (US); Navjot Singh, Somerset, NJ (US)

(21) Appl. No.: 14/983,068

(22) Filed: Dec. 29, 2015

Related U.S. Application Data
(60) Provisional application No. 62/105,436, filed on Jan. 20, 2015.

(51) Int. Cl. H04M 3/51; H04M 3/523

(52) U.S. Cl. CPC H04M 3/5183; H04M 3/5233

(57) ABSTRACT

A contact center, communication system, and server are disclosed. An illustrative contact center is disclosed as being a multichannel contact center. A customer of the illustrative multichannel contact center is allowed to switch their engagement with the contact center from using a first media type to using a second media type. Upon making such a switch of engagement, the customer may be provided with information regarding resources in the contact center, statistics/metrics of those resources, the ability to provide real-time feedback regarding the engagement, and possibly the ability to select a resource from among a plurality of resources. In this way, the customer may be incentivized to switch their method of engagement to a benefit of both the contact center and the customer.

### CROSS-REFERENCE TO RELATED APPLICATIONS

The present application claims the benefit of U.S. Provisional Patent Application No. 62/105,436, filed on Jan. 20, 2015, the entire contents of which are hereby incorporated herein by reference.

### FIELD OF THE DISCLOSURE

The present disclosure is generally directed to contact centers and, in particular, toward multichannel contact centers.

### BACKGROUND

Customer satisfaction is often an important consideration for contact centers and their administrators. Most customer satisfaction is analyzed post-hoc (e.g., via a survey after the customer is no longer interacting with the agent). Furthermore, most contact centers only allow a customer to engage the resources of the contact center via a single communication channel at a time.

### BRIEF DESCRIPTION OF THE DRAWINGS

FIG. 1 depicts a block diagram of a communication system in accordance with at least some embodiments of the present disclosure;

FIG. 2 is a block diagram depicting components of a server used in a contact center in accordance with at least some embodiments of the present disclosure;

FIG. 3A is a block diagram depicting a first illustrative configuration of a multichannel contact center interaction in accordance with at least some embodiments of the present disclosure;

FIG. 3B is a block diagram depicting a second illustrative configuration of a multichannel contact center interaction in accordance with at least some embodiments of the present disclosure;

FIG. 3C is a block diagram depicting a third illustrative configuration of a multichannel contact center interaction in accordance with at least some embodiments of the present disclosure;

FIG. 3D is a block diagram depicting a fourth illustrative configuration of a multichannel contact center interaction in accordance with at least some embodiments of the present disclosure;

FIG. 3E is a block diagram depicting a fifth illustrative configuration of a multichannel contact center interaction in accordance with at least some embodiments of the present disclosure;

FIG. 4 is a flow diagram depicting a method of incentivizing a customer to engage in a multichannel communication with a contact center in accordance with at least some embodiments of the present disclosure;

FIG. 5 is a flow chart depicting a method of receiving real-time customer feedback in a multichannel contact center in accordance with at least some embodiments of the present disclosure;

FIG. 6 is a flow chart depicting a method of acting on customer feedback received in real-time in accordance with at least some embodiments of the present disclosure;

FIG. 7 is a flow chart depicting a method of allowing a customer to optimize their contact center journey in accordance with at least some embodiments of the present disclosure; and

FIG. 8 is a flow chart depicting a method of using a second communication channel to decrease a handling time for a customer on a first communication channel in accordance with at least some embodiments of the present disclosure.

### DETAILED DESCRIPTION

Embodiments of the present disclosure will be described in connection with the execution of a multichannel contact center. As will be discussed herein, the term “multichannel” can refer to a contact center having one or multiple different channels of communication with a single customer. A channel of communication may correspond to a physical channel (e.g., a data path across a communication network that includes a plurality of nodes and interconnecting wired or wireless communication links), a logical channel (e.g., a protocol-dependent communication modality), and/or combinations thereof. It should also be appreciated that different communication channels may or may not carry different media types. For instance, one communication channel may be capable of carrying first and second media types (e.g., voice and data) and a second communication channel may be capable of carrying only one of those media types (e.g., data). In such an example, the communication channels do not necessarily carry mutually exclusive media types. In another example, one communication channel may carry one media type (e.g., video, which is a combination of image and voice) and another communication channel may carry a different media type (e.g., data). As will be discussed herein, embodiments of the present disclosure consider the deployment of a contact center that enables a flexible interaction with a customer and one way of achieving such flexibility is with the presentation of media/channel communication options.

As a non-limiting example, embodiments of the present disclosure propose a way of improving a customer journey through a contact center with the use of a multichannel contact center. One way such a journey can be improved is if a customer is initially on a voice channel (e.g., RS-232, SIP, VoIP, etc.) and waiting for service, then an Interactive Voice Response (IVR) system may instruct the customer that if they establish a data channel with the contact center, then the customer may be provided with information about the agents that will soon be available. In some embodiments, a “reverse screen pop” (or similar dialog delivered via HTML, XML, etc.) can be delivered to the customer via a data channel and may provide the customer with information about the agents that are soon to be available for assignment to a new customer. The customer may also be informed of each agent's estimated availability time and their skills via this reverse screen pop. The customer may then be allowed to select or provide a preference for an agent based on the information provided to the customer. For instance, the customer may select an agent that requires the customer to wait a little longer, but the customer is happier with the selection because they feel like they will receive better service. Conversely, the customer's impatience or unwillingness to wait can be gauged if it is determined that the customer selected an inferior or less-skilled agent based on a lower Expected Wait Time (EWT) associated with that agent. In this way, the customer is given some control over their contact center journey, thereby increasing their satisfaction with the journey. It may also be possible to let the customer select an agent they have worked with in the past, even if that agent will not be available for some time. The reverse screen pop may also provide the customer with the ability to setup an automatic call back on their voice line once that agent actually becomes available.

As another non-limiting example, the availability of multiple channels of communication between a contact center and a customer also enables the contact center to change the modules used to monitor the quality of the interaction between the customer and the contact center resources. For instance, based on feedback or speech analysis, the contact center may be intelligent enough to activate some other module not currently activated for that interaction (e.g., screen capture, voice recording, etc.) to assist with the interaction. As additional modules are brought into the interaction, then an analytics module can analyze the multiple sources of data on some or all of the communication channels that are being used by the customer to determine if the agent requires supervisor assistance, for example. Furthermore, if supervisor assistance is needed, then a work flow engine in the contact center may be configured to determine the best channel to use in connecting the supervisor with the customer and agent.

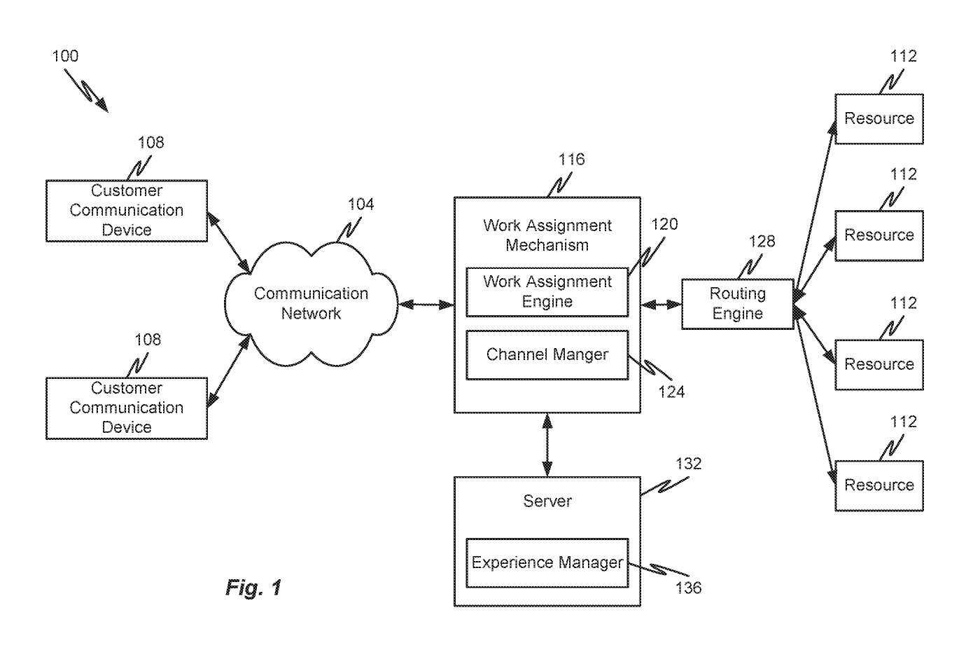

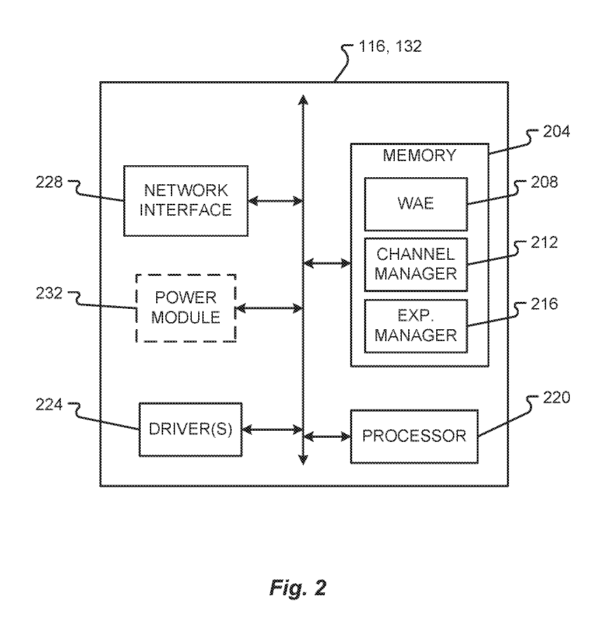

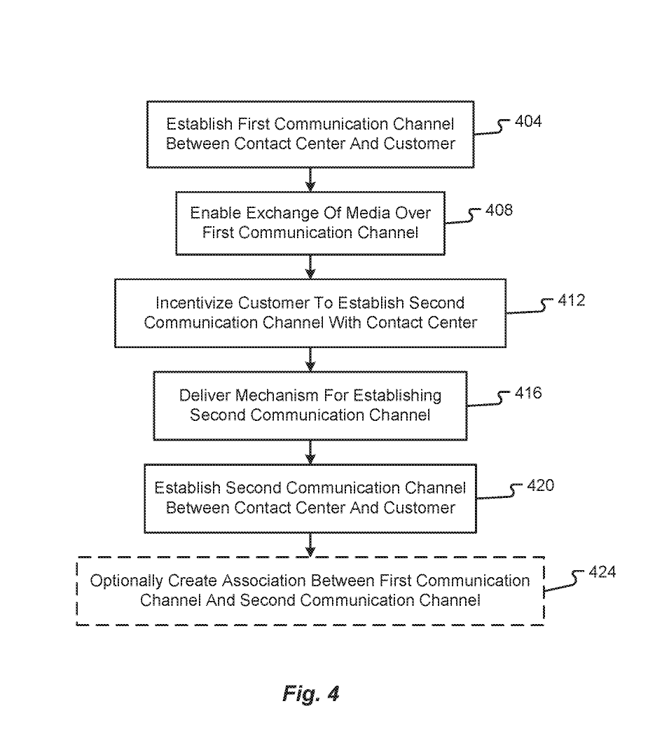

With reference now to FIGS. 1-8, various examples or features capable of deployment with a multichannel contact center will be described in accordance with at least some embodiments of the present disclosure. The following description is not intended to limit the claims to any particular embodiment described in connection with a particular figure. To the contrary, elements from any of the figures may be combined with other elements from other figures to provide a functional and efficient multichannel contact center. For instance, the features of FIG. 1 or 2 may be adapted to perform some or all of the methods described in any of FIGS. 4-8.

With reference initially to FIG. 1, an illustrative communication system 100 will be described in accordance with at least some embodiments of the present disclosure. The communication system 100 of FIG. 1 may be a distributed system and, in some embodiments, comprises a communication network 104 connecting one or more customer communication devices 108 to a work assignment mechanism 116, which may be owned and operated by an enterprise administering a contact center in which a plurality of resources 112 are distributed to handle incoming work items from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Voice over Internet Protocol (VoIP) network, a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. The communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 128 to connect the communication device 108 to the assigned resource(s) 112.

Although the routing engine 128 is depicted as being separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, tablet, cellular phone, smartphone, telephone, or combinations thereof. In general, each communication device 108 may be adapted to support video, audio, text, and/or data communications with other communication devices 108 as well as the processing resources 112. The type of physical medium used by the communication device 108 to establish a communication channel or multiple communication channels with the resources 112 of the contact center may depend upon the capabilities of the communication device 108, the capabilities of the contact center and the contact center resources 112, the type of network 104 connecting the communication device(s) 108 with the resources 112, etc. It should be appreciated that any media type may be used to exchange communications between a customer and resource 112 and one or a plurality of communication channels (e.g., physical or logical pathways) may carry these different media types.

The work assignment mechanism 116 (or a server deploying the work assignment mechanism 116) may further include a channel manager 124 that is configured to manage the utilization of the various communication channels within the contact center. In some embodiments, the channel manager 124 may correspond to a set of instructions stored in computer memory that, when executed by a microprocessor, enable the contact center to operate as a multichannel contact center. The channel manager 124 may further enable a customer to optimize/control their journey through the contact center. Further still, the channel manager 124 may be configured to solicit a customer to engage with the contact center via more than one communication channel, even if only for the resolution of a single work item.

In accordance with at least some embodiments of the present disclosure, the work item can be sent toward a collection of processing resources 112 via the combined efforts of the work assignment mechanism 116 and routing engine 128. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In addition to the channel manager 124, the work assignment mechanism 116 comprises a work assignment engine 120 which enables the work assignment mechanism 116 to make intelligent routing decisions for work items. In some embodiments, the work assignment engine 120 can determine which of the plurality of processing resources 112 is qualified and/or eligible to receive the work item and further determine which of the plurality of processing resources 112 is best suited (or is the optimal processing resource) to handle the processing needs of the work item. In situations of work item surplus, the work assignment engine 120 can also make the opposite determination (i.e., determine optimal assignment of a work item resource to a resource).

The contact center may further include a server 132 or collection of servers that assist with the management of customer's experience while interacting with the contact center and resources 112 of the contact center. In some embodiments, the server(s) 132 include an experience manager 136 that may be embodied as instructions in memory that are executable by a microprocessor of the server 132. The experience manager 136, when executed, may enable the contact center to deliver additional channels of communication (or offers for such) to a customer's communication device 108, determine that multiple communication channels have been established by a customer but are related to a single work item, monitor the various communication channels being used by a customer to determine if the customer is satisfied/dissatisfied, etc. The experience manager 136 may also be equipped to deploy one or more remedial measures if a customer is determined to be dissatisfied or less than totally satisfied with their customer service experience in the contact center. Examples of remedial measures that may be deployed include, without limitation, alerting a supervisor, connecting a supervisor to one of the communication channels, including a speech analytics module into the communication session to further analyze the interaction, starting a recording of the interaction or media exchanged during the interaction, etc.

Although the server 132 is depicted as being separate from the work assignment mechanism 116, it should be appreciated that these two elements may be combined. For example, the server 132 may deploy the experience manager 136 and some or all of the components of the work assignment mechanism 116. Alternatively or additionally, the work assignment mechanism 116 may deploy the experience manager 136 as a separate component or as part of the channel manager 124.

With reference now to FIG. 2, additional details of a server 116, 132 that may be used within a multichannel contact center will be described in accordance with at least some embodiments of the present disclosure. The server 116, 132 is shown to include computer memory 204 that stores one or more instructions sets, applications, or modules, potentially in the form of a work assignment engine 208, channel manager 212, and/or experience manager 216. The server 116, 132 is also shown to include a processor 220, one or more drivers 224, a network interface 228, and an optional power module 232.

The memory 204 may correspond to any type of non-transitory computer-readable medium. In some embodiments, the memory 204 may comprise volatile or non-volatile memory and a controller for the same. Non-limiting examples of memory 204 that may be utilized in the reader 108 include RAM, ROM, buffer memory, flash memory, solid-state memory, or variants thereof. Any of these memory types may be considered non-transitory computer memory devices even though the data stored thereby can be changed one or more times.

The applications/instructions 208, 212, 216 may correspond to any type of computer-readable instructions storable in memory 204. The functions of the instructions 208, 212, 216 may be similar or identical to the work assignment engine 120, channel manager 124, and experience manager 136, respectively. FIG. 2 is illustrative for purposes of showing a single server implementing all of the possible contact center modules described in connection with FIG. 1. It should be appreciated that a server 116, 132 may implement only a subset of the applications/instruction sets stored in memory 204.

The processor 220 may correspond to one or many microprocessors that are contained within a common housing or blade with the memory 204. The processor 220 may be a multipurpose, programmable device that accepts digital data as input, processes the digital data according to instructions stored in its internal memory, and provides results as output. The processor 220 may implement sequential digital logic as it has internal memory. As with most known microprocessors, the processor 220 may operate on numbers and symbols represented in the binary numeral system.

The driver(s) 224 may correspond to hardware, software, and/or controllers that provide specific instructions to hardware components of the server 116, 132, thereby facilitating their operation. For instance, the network interface 228 and/or memory 204 may each have a dedicated driver 224 that provides appropriate control signals to effect their operation. The driver(s) 224 may also comprise the software or logic circuits that ensure the various hardware components are controlled appropriately and in accordance with desired protocols. For instance, the driver 224 of the network interface 228 may be adapted to ensure that the network interface 228 follows the appropriate network communication protocols (e.g., TCP/IP (at one or more layers in the OSI model), UDP, RTP, GSM, LTE, Wi-Fi, etc.) such that the network interface 228 can exchange communications via the communication network 104. As can be appreciated, the driver(s) 224 may also be configured to control wired hardware components (e.g., a USB driver, an Ethernet driver, fiber optic communications, etc.).

The network interface 228 may comprise hardware that facilitates communications with other communication devices over the communication network 104. As mentioned above, the network interface 228 may include an Ethernet port, a Wi-Fi card, a Network Interface Card (NIC), a cellular interface (e.g., antenna, filters, and associated circuitry), or the like. The network interface 228 may be configured to facilitate a connection between the server 116, 132 and the communication network 104 and may further be configured to encode and decode communications (e.g., packets) according to a protocol utilized by the communication network 104.

The power module 232 may include a built-in power supply (e.g., battery) and/or a power converter that facilitates the conversion of externally-supplied AC power into DC power that is used to power the various components of the server 116, 132. In some embodiments, the power module 232 may also include some implementation of surge protection circuitry to protect the components of the server 116, 132 from power surges.

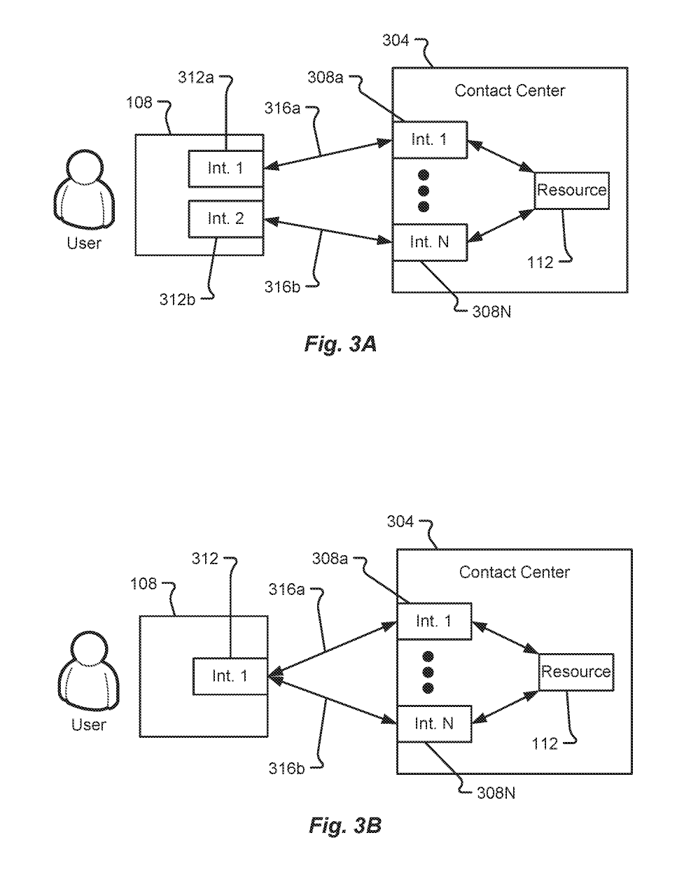

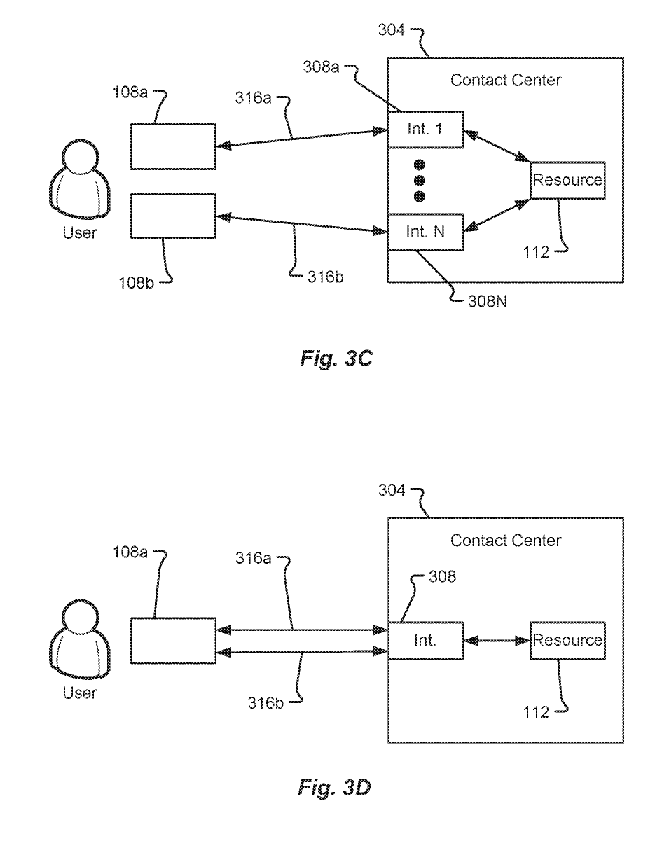

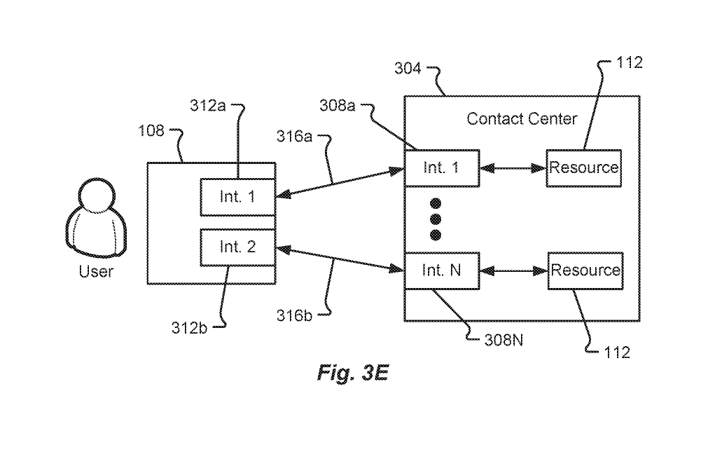

With reference now to FIGS. 3A-E, various possible configurations of a multichannel contact center 304 will be described in accordance with at least some embodiments of the present disclosure. The various configurations are not intended to be limiting and may be combinable. For instance, aspects of the configuration in FIG. 3A may be modified to accommodate aspects of the configuration in FIG. 3E, or vice versa. Indeed, the following discussion of possible contact center 304 configurations is for illustrative purposes only.

FIG. 3A illustrates a first configuration of a multichannel contact center 304 interaction with a user/customer in accordance with at least some embodiments of the present disclosure. This first possible configuration shows the contact center 304 as having up to N communication interfaces 308a-N, where N is an integer value greater than or equal to 1. Each communication interface 308a-N may correspond to a particular communication port in the contact center 304, a particular communication port/network interface 228 of a server 116, 132, or the like. In some embodiments, each interface 308a-N is addressed separately, meaning that a communication channel 316a established over the first interface 308a will not interfere with a communication channel 316b established over another interface (e.g., the Nth interface 308N). In some embodiments, each communication channel 316a, 316b may be configured to carry media of a different type or of the same type. As a non-limiting example, the first communication channel 316a may carry voice packets between the customer's communication device 108 and the contact center 304 whereas the second communication channel 316b may carry data packets between the customer's communication device 108 and the contact center 304. In another non-limiting example, the first communication channel 316a may carry data using a web-based communication protocol (e.g., HTTP, SMTP, etc.) while the second communication channel 316b may carry video using a video-delivery communication protocol (e.g., SIP, H.245, H.263, H.323, etc.).

In the embodiment depicted in FIG. 3A, the first communication channel 316a travels between a first interface 312a of the customer's communication device 108 and the first interface 308a of the contact center 304. The second communication channel 316b travels between a second interface 312b of the customer's communication device 108 and the Nth interface 308N of the contact center 304. It should be appreciated that more than two communication channels 316 may be established between a customer's communication device 108 and the contact center 304 without departing from the scope of the present disclosure. The communication channels 316a, 316b may be established over a common network 104 even though different interfaces are used. Furthermore, since there are two or more communication channels 316a, 316b established between the customer and contact center 304, the contact center 304 may view each communication as different work items unless some intelligence is built into the contact center 304. In some embodiments, it may become desirable to logically bind or associate the two different communication sessions over the communication channels 316a, 316b so that the contact center 304 is able to view the multiple communication sessions as a single work item or customer interaction. In other words, even though the different communication channels 316a, 316b carry different media and different content, both channels 316a, 316b may be routed to the same contact center resource 112 (e.g., agent), thereby allowing the resource 112 to interact with the customer via the multiple channels.

The communication interfaces 312a, 312b of the customer's communication device 108 may be similar or identical to the network interfaces 228 described in connection with the server 116, 132. In particular, the communication interfaces 312a, 312b may correspond to hardware and/or software provided on the customer's communication device 108 that enables communication over the communication network 104. The interfaces 312a, 312b may correspond to an Ethernet port, a cellular interface, an H.323 interface, a WiFi interface, etc.

FIG. 3B shows a second possible configuration where a single interface 312 on the customer's communication device 108 is used for both the first communication channel 316a and the second communication channel 316b. In this particular embodiment, the interface 312 may deliver different media types to different interfaces 308a, 308N of the contact center 304. A non-limiting example of such a configuration may correspond to a customer using a smartphone to engage in a voice call over the first communication channel 316a and then a browser on the smartphone to exchange data over the second communication channel 316b. Another non-limiting example may correspond to a customer using a desktop computing device to engage in a video call or chat over the first communication channel 316a and then a browser on the computing device to exchange data over the second communication channel 316b using HTTP, HTTPS, or the like.

FIG. 3C shows a third possible configuration where the customer utilizes two different communication devices 108a, 108b to communicate with the contact center 304. In this scenario, the first communication device 108a is used to establish the first communication session over the first communication channel 316a whereas the second communication device 108b is used to establish a second communication session over the second communication channel 316b. As with FIGS. 3A and 3B, the contact center 304 still employs two different communication interfaces 308a, 308N to facilitate the multichannel communication with the customer. A non-limiting example of this particular configuration may correspond to a scenario where the customer uses a phone or smartphone as the first communication device 108a to exchange voice and/or video with the contact center 304 over the first communication channel 316a where a tablet or personal computing device is used to exchange data or chat with the resource 112 via the second communication channel 316b.

FIG. 3D illustrates a fourth possible configuration that is similar to the configuration of FIG. 3B, except that the contact center 304 employs a single interface 308 to carry the media from both the first communication channel 316a and the second communication channel 316b. This particular configuration may be afforded when a single communication link or protocol enables the exchange of multiple types of media. A non-limiting example of such a scenario may be with the utilization of HTTP and WebRTC, where data is exchanged over the first communication channel 316a using HTTP or the like and WebRTC is used to carry voice or video on top of the data being carried using the first communication channel 316b. While contents of both communication channels 316a, 316b are addressed to the same interface 308, the communication channels 316a, 316b may be considered separate due to the fact that each channel is carrying media of a different type.

FIG. 3E illustrates a fifth possible configuration whereby the customer is connected with two different resources 112 within the contact center 304. In some embodiments, content carried via the first communication channel 316 is delivered to a first resource 112 in the contact center 304 whereas content carried via the second communication channel 316b is delivered to a second resources 112 in the contact center 304. In some embodiments, both resources 112 may be human agents. In some embodiments, one of the resources 112 may be a human agent whereas the other resource 112 may be an automated resource (e.g., an IVR, a recording application, an automated response chat bot, etc.). In this scenario, the contact center 304 may have additional logic to create an association or binding between the communication sessions being carried out on the two different communication channels 316a, 316b. This binding may occur by determining that both sessions involve the same customer, the same customer communication device 108, or via some other mechanism (e.g., via delivery of a code over one communication channel 316a, which allows the customer to confirm that the other communication channel 316b should be bound thereto).

With reference now to FIG. 4, a flow diagram depicting a method of incentivizing a customer to engage in a multichannel communication with a contact center 304 will be described in accordance with at least some embodiments of the present disclosure. The method begins by establishing a first communication channel 316a between the contact center 304 and the customer (step 404). The first communication channel 316a may correspond to a first negotiated connection between the contact center 304 and the customer's communication device 108. Any type of media may be carried across the first communication channel 316a (step 408). As a non-limiting example, the first communication channel 316a may carry voice or video media between the customer's communication device 108 and the contact center 304.

As the customer interacts with the contact center 304 (or more specifically a resource 112 of the contact center 304), there may be a determination made by the contact center 304 (or a resource 112 interacting with the customer) that the customer's interaction with the contact center 304 may be enhanced or improved with the addition of a second communication channel 316b. In such a situation, the customer may be provided with messaging or the like which incentivizes the customer to establish a second communication channel 316b with the contact center (step 412). Such incentives may include a promise of differentiated treatment in the contact center (e.g., giving the customer additional information not available to customers which do not establish a second communication channel, reducing the customer's handling time, reducing the customer's wait time for an agent, providing the customer with additional media to improve his/her experience, providing the customer with a conduit for real-time feedback, etc.).

If the customer so chooses to establish the second communication channel 316b, the customer may be delivered with a mechanism for establishing the second communication channel 316b (step 416). In some embodiments, this particular mechanism may include a code or number which enables the customer to connect the second communication channel 316b with the resource handing the first communication channel 316a or a code which binds the communication sessions over each channel with one another. In other embodiments, the customer's communication device may be provided with an invitation to establish the communication session over the second communication channel (e.g., a hyperlink in a chat window or web page). If the customer responds to the invitation, clicks the link, or otherwise decides to respond affirmatively to the incentive provided by the contact center 304, then the method continues with the establishment of the second communication channel 316b between the customer's communication device 108 and the contact center 304 (step 420). An optional step may also be performed whereby the contact center 304 creates an association between the first communication channel 316a and the second communication channel 316b, thereby enabling the contact center 304 to treat both communication sessions as a single interaction with the customer (step 424). This association may be maintained in a database of the contact center 304 or by connecting both communication channels 316a, 316b to a common resource 112 (e.g., a single agent). Furthermore, the association may enable reporting for the customer's interaction with the contact center 304 to account for content exchanged over both communication channels 316a, 316b.

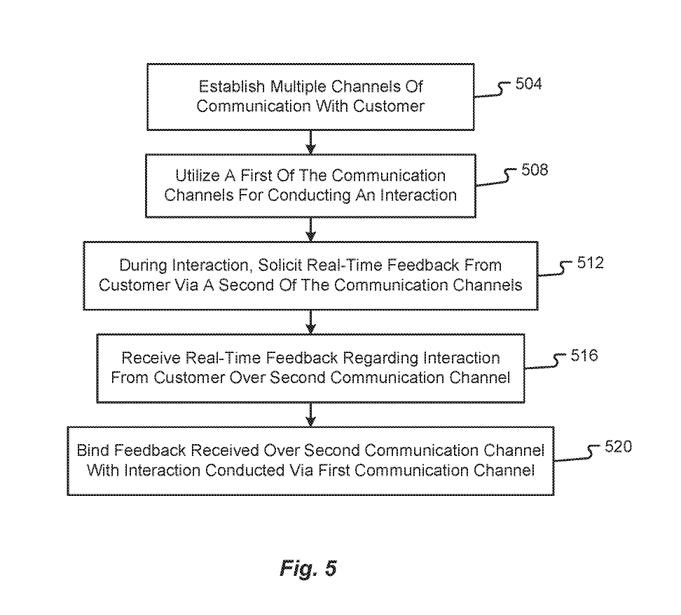

With reference now to FIG. 5, a flow chart depicting a method of receiving real-time customer feedback in a multichannel contact center 304 will be described in accordance with at least some embodiments of the present disclosure. The method begins when multiple communication channels (e.g., at least a first communication channel 316a and second communication channel 316b) are established between a customer and the contact center 304 (step 504). A first of the multiple communication channels may be used to conduct an interaction between the customer and the contact center 304 (or more precisely resources 112 of the contact center) (step 508). As an example, the interaction may correspond to a voice call between the customer and an agent of the contact center 304, a chat between the customer and an agent of the contact center 304, a video call between the customer and an agent of the contact center 304, etc.

During this interaction over the first communication channel 316a, the customer's feedback or input regarding the interaction may be solicited via a second of the multiple communication channels 316b (step 512). The feedback may be solicited periodically, at a predetermined time in the interaction (e.g., after the interaction has lasted for at least X minutes), or in response to predetermined events occurring in the interaction (e.g., detecting a key word, a key phrase, a customer's sentiment, etc.). Moreover, the second communication channel 316b may or may not carry the same media as the first communication channel 316a. As a non-limiting example, the first communication channel 316a may facilitate real-time communications (e.g., voice or video) whereas the second communication channel 316b may carry data or near-real-time communications such as a chat or Instant Message (IM). In this way, the customer can continue interacting in real time over the first communication channel 316a, but may simultaneously provide feedback regarding the interaction over the second communication channel 316b, without necessarily disrupting the interaction on the first communication channel 316a (step 516). In other words, it may be more disruptive (although not impossible) for the customer's feedback to be provided using a real-time communication (e.g., voice, video, etc.) if the interaction is also occurring in real-time.

The customer's feedback may or may not be provided to the resource/agent that is interacting with the customer via the first communication channel 316a. In some embodiments, the feedback may be used to generate a quality report or quality/satisfaction metric for the interaction as well as a satisfaction indicator for the agent's performance. This feedback may be bound with the interaction conducted over the first communication channel 316a (step 520). Furthermore, the ability to obtain the customer's feedback in real time (e.g., while the interaction is occurring) and without necessarily requiring such feedback to be provided directly to the agent over the first communication channel 316a liberates the customer to provide more candid and meaningful feedback regarding the interaction.

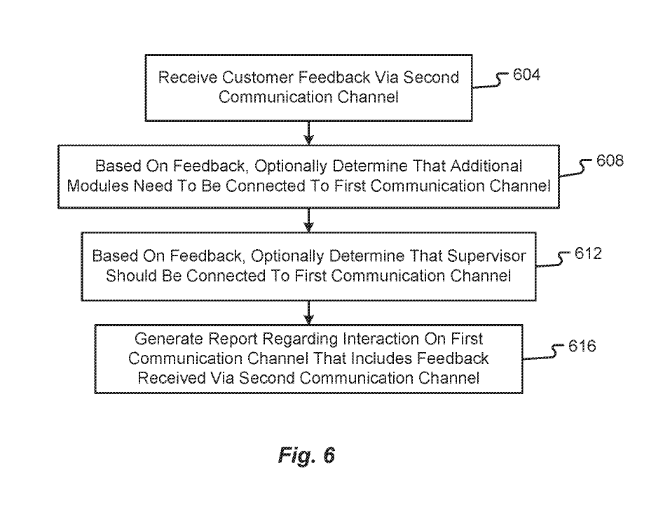

With reference now to FIG. 6, a flow chart depicting a method of acting on customer feedback received in real-time will be described in accordance with at least some embodiments of the present disclosure. The steps of this particular method, in some embodiments, may replace, be combined with, or augment one or more steps of the method described in connection with FIG. 5. The method of FIG. 6 begins when customer feedback (e.g., real-time feedback) is received over a second communication channel 316b (step 604). Based on the receipt of this feedback, the nature of the feedback, etc., the method continues by optionally determining that an additional module (e.g., an automated resource 112 such as an IVR, voice recording unit, agent assist feature, training module, etc.) should be connected to the first communication channel 316a to assist with the interaction occurring between the customer and the contact center 304 (step 608). Also based on the feedback, another optional determination may be made to include a supervisor on the interaction. If such a determination is made, then the appropriate supervisor may be connected to the first communication channel to assist the customer in completing their transaction over the first communication channel 316a (step 612).

Based on the feedback as well as any remedial measures deployed by the contact center 304, a report regarding the interaction between the customer and the contact center 304 over the first communication channel 316a may be generated (step 616). In particular, content from the feedback obtained over the second communication channel 316b may be included in a report or generation of a Key Performance Indicator (KPI) to describe the agent/resources 112 performance during the interaction conducted over the first communication channel 316a. In other words, the feedback received over one communication channel may be applied to an interaction that occurred over a different communication channel.

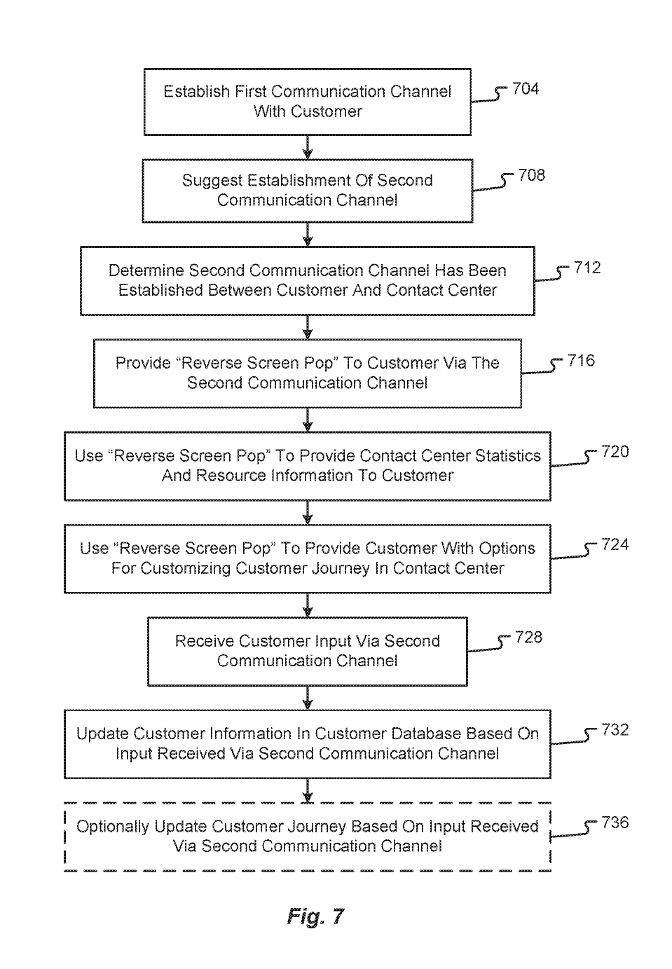

With reference now to FIG. 7, a method of allowing a customer to optimize their contact center journey will be described in accordance with at least some embodiments of the present disclosure. The method begins with the establishment of a first communication channel 316a between a customer and the contact center 304 (step 704). This may occur by virtue of the customer initiating a session with the contact center 304 (e.g., calling the contact center, requesting a chat session, etc.), by virtue of the contact center 304 initiating a session with the customer (e.g., the contact center dialing the customer in an outbound dialing campaign, responding to a social media posting made by the customer on a social media website, etc.).

After the first communication channel 316a is established, the contact center 304 may suggest the establishment of a second communication channel 316b (step 708). The contact center 304 then waits until it is able to determine that the second communication channel 316b has been established (step 712). In some embodiments, this includes having the contact center 304 wait and monitor for a customer's response to the suggestion to establish the second communication channel 316b.

The contact center 304 may then provide the customer with a reverse screen pop or similar form of dialog box via the second communication channel 316b (step 716). In some embodiments, the customer may be provided with contact center statistics or KPIs (e.g., utilization rate, average wait time among a group of customers, current estimated wait time, current handling time, average handling time, etc.) (step 720). In this step, the customer may also be provided with information regarding one or more resources 112. The provided information may correspond to an identification of resources 112/agents which are currently available or which are anticipated to become available within a predetermined amount of time. The customer can further be provided with one or more options for customizing their journey in the contact center via the reverse screen pop (step 724). In some embodiments, this customization may include querying the customer as to which agent(s) the customer is more desirous of having assigned thereto or less desirous of having assigned thereto. The customer may then provide their selections to the contact center 304 via the second communication channel 316b and this information may be used to guide or assist with handling the communication session on the first communication channel 316a (step 728).

As a non-limiting example, the customer may be provided with a roster of five agents, two of whom are currently available and three of whom are expected to become available within 3 minutes. If the customer selects one of the available agents even though those agents were identified as not having the best skill match for the customer's call, then the contact center 304 may be able to surmise that the customer is somewhat impatient and willing to sacrifice interaction/handling quality for timeliness. On the other hand, if the customer selects a non-available agent then it can be surmised that the customer is more willing to wait for a higher quality agent. This information can be incorporated into a customer relationship management (CRM) database to help guide future interactions with the customer (step 732). If possible, it may also be desirable to update the customer's journey based on their inputs (step 736). More specifically, it may not always be possible to provide the customer with their selected journey or course of action (e.g., connect the customer with their selected agent). However, if possible the customer's journey can be guided/managed within the contact center based on the customer's preferences/desires received via the second communication channel 316b.

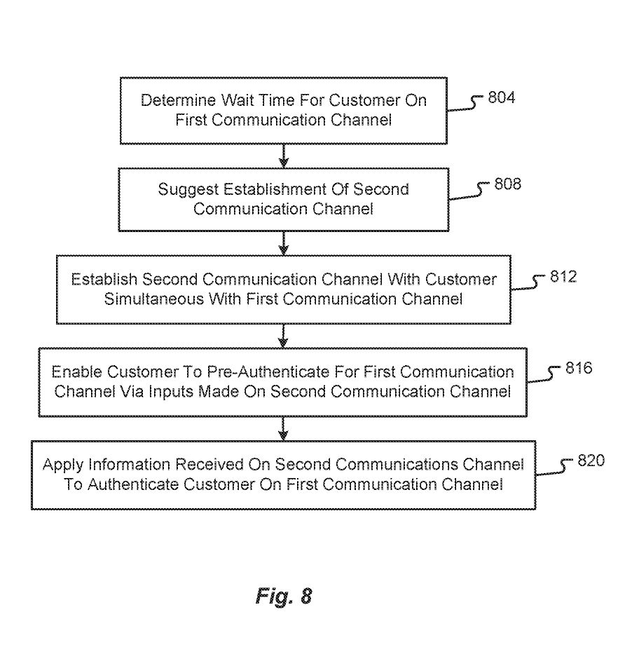

With reference now to FIG. 8, a flow chart depicting a method of using a second communication channel 316b to decrease a handling time for a customer on a first communication channel 316a will be described in accordance with at least some embodiments of the present disclosure. The method begins by determining a wait time or estimated wait time for a customer on a first communication channel 316a (step 804). The estimated wait time may be based, at least in part, upon the number of other customers waiting for service via a similar media, the number of other customers waiting for service via a similarly skilled resource 112, current contact volume, average handling time, velocity of a work queue, etc.

The customer may then be provided with the estimated wait time and a suggestion to establish a second communication channel 316b to potentially improve such wait time (step 808). In some embodiments, the suggestion may be provided via an IVR or similar automated mechanism. In some embodiments, the suggestion may be provided at the onset of the call when the estimated wait time is announced to the customer.

If the customer elects to establish the second communication channel 316b simultaneous with the first communication channel 316b, then the contact center 304 now has two different paths by which to interact with the customer (step 812). This may enable the customer to provide information over the second communication channel 316b that will decrease handling time on the first communication channel 316a and/or reduce wait time on the first communication channel 316a (step 816). As a non-limiting example, the customer may provide a certain amount of information that is usually required for authentication/identification. The customer's inputs provided on the second communication channel 316b may be applied to the communication session on the first communication channel 316a (step 820). In particular and as a non-limiting example, the customer may be connected with an agent in the same amount of time as if the second communication channel 316b wasn't used, but the agent may not need to authenticate the customer over the first communication channel 316a since the authentication was already performed via the second communication channel 316b. Moreover, since the customer pre-authenticated over the second communication channel 316b, it may be possible to move the customer ahead in the queue (or to a different queue with a different wait time) without negatively impacting those customers that were skipped since the amount of time saved due to pre-authentication may be greater than the amount of time lost due to moving the customer ahead in queue.

While illustrative embodiments of the disclosure have been described in detail herein, it is to be understood that the inventive concepts may be otherwise variously embodied and employed, and that the appended claims are intended to be construed to include such variations, except as limited by the prior art.

Moreover, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the description.

What is claimed is:

1. A contact center, comprising:
a work assignment engine which receives contacts from customers, generates a corresponding work item for the contacts received from the customers, and selects one or more resources in the contact center to connect with the customer such that the customer can receive service from the contact center;
a channel manager that facilitates the contact center to connect with a first customer simultaneously via both a first communication channel and a second communication channel; and
an experience manager that binds information received during a communication session on the second communication channel with a communication session occurring on the first communication channel.

2. The contact center of claim 1, wherein the first communication channel and the second communication channel are addressed to different network interfaces of the contact center.

3. The contact center of claim 2, wherein the first communication channel carries at least one media type that is different from the second communication channel.

4. The contact center of claim 3, wherein the communication session on the first communication channel is a real-time communication session, wherein the communication session on the second communication channel is a non-real-time communication session, and wherein information provided by the first customer over the second communication channel is used to generate a report or Key Performance Indicator (KPI) for an agent communicating with the first customer over the first communication channel.

5. The contact center of claim 4, wherein the information provided by the customer over the second communication channel comprises the first customer's real-time feedback for the communication session occurring on the first communication channel and wherein the real-time feedback is received while the communication session is occurring on the first communication channel.

6. The contact center of claim 1, wherein the contact center provides the first customer with a reverse screen pop via the second communication channel thereby enabling the first customer to define a desired treatment on the first communication channel.

7. The contact center of claim 6, wherein the first customer is provided with information regarding the contact center or resources of the contact center and is further allowed to select a desired resource from within the reverse screen pop.

8. The contact center of claim 7, wherein the customer's selection of the desired resource is used by the work assignment engine to make a work assignment decision for the work item associated with the first customer.

9. The contact center of claim 1, wherein a remedial measure for the communication session occurring on the first communication channel is selected based on customer feedback provided via the second communication channel.

10. A communication system that enables multichannel communications between a customer and one or more resources of a contact center, the communication system comprising:
a first communication interface that facilitates communications with customer communication devices via a first communication channel;
a second communication interface that facilitates communications with customer communication devices via a second communication channel; and
an experience manager that is executable by a microprocessor and which binds information received during a communication session on the second communication channel with a communication session occurring on the first communication channel.

11. The communication system of claim 10, wherein the first communication channel carries at least one media type that is different from the second communication channel.

12. The communication system of claim 11, wherein the communication session on the first communication channel is a real-time communication session, wherein the communication session on the second communication channel is a non-real-time communication session, and wherein information provided by the first customer over the second communication channel is used to generate a report or Key Performance Indicator (KPI) for an agent communicating with the first customer over the first communication channel.

13. The communication system of claim 12, wherein the information provided by the customer over the second communication channel comprises the first customer's real-time feedback for the communication session occurring on the first communication channel and wherein the real-time feedback is received while the communication session is occurring on the first communication channel.

14. The communication system of claim 10, wherein the contact center provides the first customer with a reverse screen pop via the second communication channel thereby enabling the first customer to define a desired treatment on the first communication channel.

15. The communication system of claim 14, wherein the first customer is provided with information regarding the contact center or resources of the contact center and is further allowed to select a desired resource from within the reverse screen pop and wherein the customer's selection of the desired resource is used by the work assignment engine to make a work assignment decision for the work item associated with the first customer.

16. The communication system of claim 10, wherein a remedial measure for the communication session occurring on the first communication channel is selected based on customer feedback provided via the second communication channel.

17. A server for use in a multichannel contact center, comprising:
a microprocessor;
computer memory including instructions stored thereon that are executable by the microprocessor, the instructions including:
a work assignment engine which receives contacts from customers, generates a corresponding work item for the contacts received from the customers, and selects one or more resources in the contact center to connect with the customer such that the customer can receive service from the contact center;
a channel manager that facilitates the contact center to connect with a first customer simultaneously via both a first communication channel and a second communication channel; and
an experience manager that binds information received during a communication session on the second communication channel with a communication session occurring on the first communication channel.

18. The server of claim 17, wherein the first communication channel carries at least one media type that is different from the second communication channel, wherein the communication session on the first communication channel is a real-time communication session, wherein the communication session on the second communication channel is a non-real-time communication session, wherein information provided by the first customer over the second communication channel is used to generate a report or Key Performance Indicator (KPI) for an agent communicating with the first customer over the first communication channel, wherein the information provided by the customer over the second communication channel comprises the first customer's real-time feedback for the communication session occurring on the first communication channel, and wherein the real-time feedback is received while the communication session is occurring on the first communication channel.

19. The server of claim 17, wherein the contact center provides the first customer with a reverse screen pop via the second communication channel thereby enabling the first customer to define a desired treatment on the first communication channel.

20. The server of claim 17, wherein a remedial measure for the communication session occurring on the first communication channel is selected based on customer feedback provided via the second communication channel.
